(19) United States
(12) Patent Application Publication
(10) Pub. No.: US 2009/0198654 A1
(43) Pub. Date: Aug. 6, 2009

(54) DETECTING RELEVANT CONTENT BLOCKS IN TEXT

(75) Inventors: Arungunram C. Surendran, Sammamish, WA (US); John C. Platt, Bellevue, WA (US); Yi Zhang, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,916

(22) Filed: Jun. 19, 2008

Related U.S. Application Data
(60) Provisional application No. 61/026,149, filed on Feb. 5, 2008.

(51) Int. Cl. G06F 17/30

(52) U.S. Cl. 707/3; 707/104.1; 707/E17.009; 707/E17.108

(57) ABSTRACT

A system that facilitates detecting a targeted topic in a document is described herein. The system includes a receiver component that receives a document. The system additionally includes a topic model component trained using a plurality of training documents including the topic and a plurality of training documents that do not include the topic. The topic model component analyzes the document and automatically determines which portions of the document include the topic and which portions of the document do not include the topic.

### RELATED APPLICATION

This application claims the benefit of U.S. Provisional Patent Application No. 61/026,149, filed Feb. 5, 2008, and entitled DETECTING RELEVANT CONTENT BLOCKS IN TEXT, the entirety of which is incorporated herein by reference.

### BACKGROUND

Computer systems are often used to create, access, and communicate documents such as web pages, e-mails, text messages, and other forms and types of documents. Such computer systems may range from a conventional PC to a mainframe, and may include mobile phones and portable music players. Pursuant to an example, computer systems may include a web browsing application that facilitates searching for and locating desired information.

In many instances, it may be desirable to determine whether a topic exists within information that may include numerous topics. For instance, it may be desirable to determine if a topic pertaining to sports exists on a particular web page (e.g., to facilitate targeted advertising). Conventional mechanisms for locating topics are often unable to locate a particular topic when information pertaining to the topic is located in a document that includes numerous topics. For instance, text categorization techniques are ineffective in connection with categorizing information when a particular topic is included in a document that includes a much larger topic or numerous topics, since the larger topics tend to “drown out” the particular topic. Furthermore, partitioning text into small portions is also associated with deficiencies, as performance tends to be relatively poor when categorizing categories that relate to a relatively small amount of text.

### SUMMARY

The following is a brief summary of subject matter that is described in greater detail herein. This summary is not intended to be limiting as to the scope of the claims.

Described herein are various technologies relating to detecting the presence or absence of information indicative of a topic in a document that also includes information not indicative of the topic. In documents that include information indicative of the topic, a determination can be made regarding which portions of the document do and do not include information indicative of the topic.

Examples of documents applicable to the described system may include text files, web pages, e-mails, text messages, word processing documents, blogs, images, or any other suitable type of document that includes at least some textual information. Such documents may also include graphical and/or photographic information. In operation, determining and/or locating relevant information in a document can be germane to web-based advertising systems, document searching systems, web page searching systems, e-mail applications, document management applications, or any other suitable system, component and/or application that manipulates and/or accesses information in documents.

In connection with determining whether a document includes a topic, multiple instance learning or other suitable learning process may be employed in connection with training a system to recognize characteristics of portions of a document that are indicative of a topic by way of evaluating negative documents that are confirmed not to include the topic and positive documents that are confirmed to include the topic (but no indication is given of where the positive documents include the topic). Pursuant to an example, documents can be manually labeled (e.g., by a human) as including or not including a particular topic. These labeled documents may be provided to a machine learning algorithm/model that can learn particular features/characteristics of the particular topic. The machine learning algorithm/model may then be employed to determine whether a never before seen document includes the topic, and if the document includes the topic, can locate the topic in the document. Detection and location of topics may be used in connection with targeted advertising, for example (e.g., one may not wish to serve advertisements in proximity to a news item pertaining to a natural disaster).

Other aspects will be appreciated upon reading and understanding the attached figures and description.

### BRIEF DESCRIPTION OF THE DRAWINGS

FIG. 1 is a functional block diagram of an example system that facilitates detection of which portions of a document include and which portions do not include information indicative of a topic.

FIG. 2 is a functional block diagram of an example system that facilitates selecting advertisements for display with a document determined to include or not include information indicative of a topic.

FIG. 3 is a functional block diagram of an example system that facilitates selecting advertisements for display with a search results listing web page determined to include or not include information indicative of a topic.

FIG. 4 is a functional block diagram of an example system that facilitates blocking access to documents determined to include information indicative of a topic.

FIG. 5 is a functional block diagram of an example system that facilitates visually highlighting messages or portions of messages that include information indicative of a topic.

FIG. 6 is a functional block diagram of an example system that facilitates training a topic model component to detect which portions of a document include and which portions do not include information indicative of a topic.

FIG. 7 is a flow diagram that illustrates an example methodology for detecting which portions of a document include and which portions do not include information indicative of a topic.

FIG. 8 is a flow diagram that illustrates an example methodology for training a topic model component.

FIG. 9 is a flow diagram that illustrates an example methodology for choosing advertisements based at least in part upon portions of a web page that do and/or do not include information indicative of a topic.

FIG. 10 is a flow diagram that illustrates an example methodology for blocking access to web pages that include information indicative of a topic.

FIG. 11 is a flow diagram that illustrates an example methodology for determining portions of an e-mail that includes information indicative of a topic.

FIG. 12 is a flow diagram that illustrates an example methodology for selecting advertisements to display based at least in part upon a determination that a web page includes a targeted topic.

FIG. 13 is an example of a computing system.

### DETAILED DESCRIPTION

Various technologies pertaining to analyzing information in documents will now be described with reference to the drawings, where like reference numerals represent like elements throughout. In addition, several functional block diagrams of examples of systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

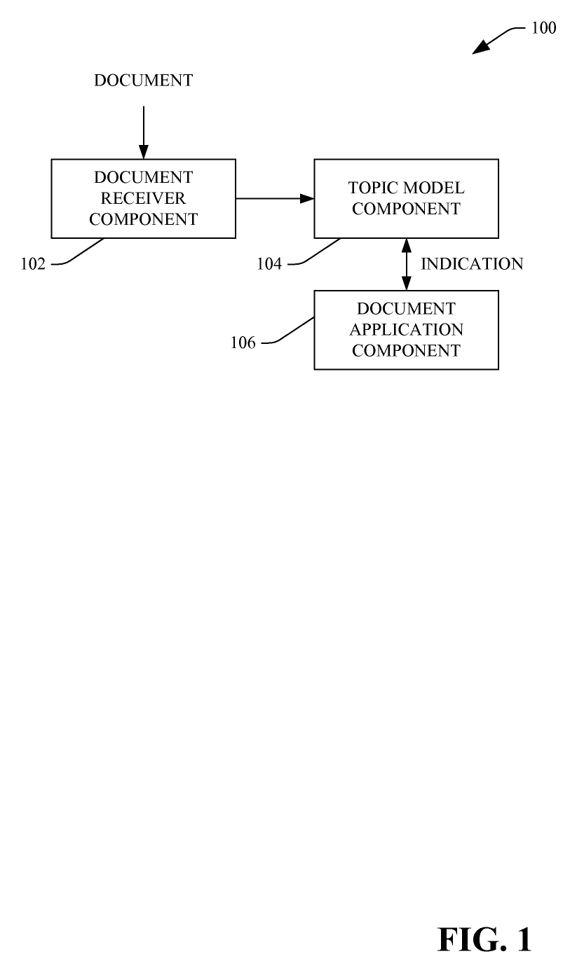

With reference to FIG. 1, an example system 100 that facilitates detection of whether a document includes information indicative of a topic is illustrated. The example system 100 also facilitates identifying which portions of a document include and which portions of the same document do not include information indicative of a topic. As used herein, a topic corresponds to information directed to any type of human identifiable idea, theme, action, person, place, thing, concept, or any other subject matter capable of being identified in documents.

The system 100 includes a document receiver component 102 that can receive a document. The system 100 also includes a topic model component 104 that, as will be explained in more detail below, can analyze information in the received document to determine which portions (if any) of the document include and which portions do not include information indicative of a topic. The system 100 may also include a document application component 106 that receives information output by the topic model component 104 and uses the provided information with respect to processing and/or using the document.

As will be described in greater detail below, the topic model component 104 can be trained to determine whether a document includes a topic by receiving and analyzing positive documents (documents that do include the topic) and negative documents (document that do not include the topic). For instance, it may be desirable to automatically determine whether a document includes a certain topic, and to facilitate training the topic model component 104 several documents that include the topic can be located and several documents that do not include the topic can be located. Pursuant to an example, the positive and negative documents for the certain topic can be located and labeled by one or more individuals. Thereafter, a suitable machine learning technique, such as Multiple Instance Learning (MIL), may be employed in connection with training the topic model component 104 to determine whether a document includes the certain topic and, if the document includes the topic, determining a location of the topic in the document. For instance, the topic model component 104 can be trained to locate features/characteristics in a document that are germane to the topic.

Documents for use with the described system may include any document that includes at least some textual information such as alphanumeric text or other language symbols that form words and sentences. However, such documents may also include other types of information such as graphics, images or other types of imbedded objects and information. Examples of documents may include text documents, web pages, e-mails, text messages, news articles, blogs, RSS feeds, word processing documents, electronic books, and any other types of electronic documents that at least in part include content in a textual form.

Such documents may include information for multiple topics. For example, a web page may include a news item or discussions regarding a particular topic as well as advertisements and/or other news items regarding different topics. Also, for example, each of the many different portions of a web page may themselves include discussions of subject matter on many different related and/or unrelated topics.

Also, for example, in the case of an e-mail, the e-mail may contain information of a variety of different topics. In addition, different portions of an e-mail may have different intended purposes. For instance, some portions of an e-mail may be directed to the purpose of providing information, while other portions of an e-mail may be directed to a purpose of a request for information or an action to be taken. Each of these different types of purposes for portions of an e-mail may be considered a different topic.

In each of these examples, only a small portion of the documents themselves may correspond to a topic that is relevant to a user or an application accessing the document. The topic model component 104 is operative to determine which portions of such documents are indicative of a topic. The topic model component 104 also is operative to determine which portions of such documents are not indicative of the topic. Either or both of the relevant and non-relevant portions of a document may be used by the document application component 106, depending on its intended use.

For instance, the document application component 106 may correspond to an application relating to provision of advertising, content-filtering, e-mail applications, document searching applications, and/or any other type of system, application and/or component which accesses and/or manipulates documents.

Also, although the document receiver component 102 and topic model component 104 are shown as separate components with respect to the document application component 106, it is to be understood that these components may be included in a common component. Further, the application component 106 itself may include the receiver component 102 and/or the topic model component 104.

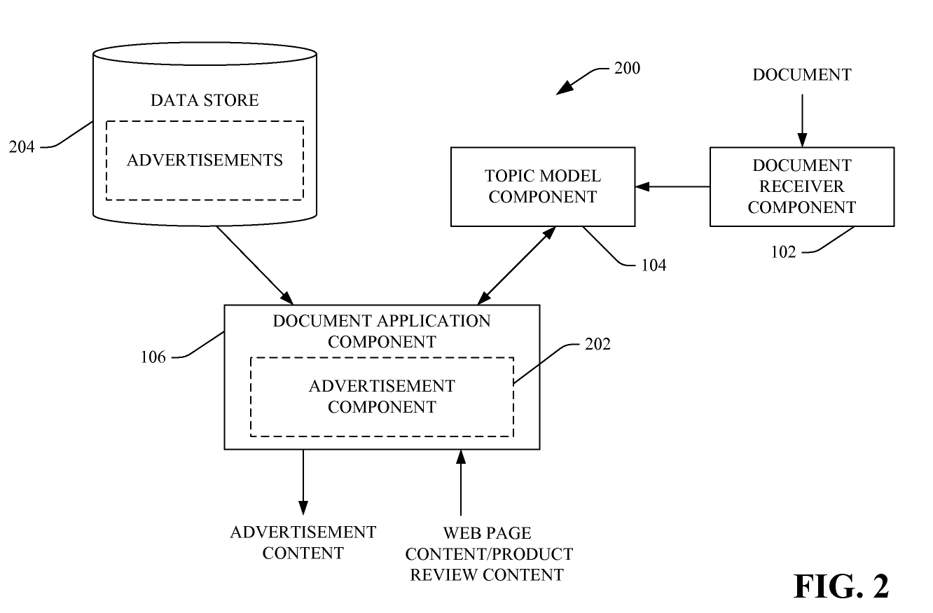

Referring now to FIG. 2, an example system 200 that facilitates selecting or labeling an advertisement based at least in part upon a determination of whether or not a topic is included in a document is illustrated. The system 200 includes the document receiver component 102 that receives a document. For instance, the document may be a web page that is visited by a user or other suitable document. The system 200 further includes the topic model component 104 that can determine whether or not the document includes a particular topic and, if the document includes the topic, can determine the location of the topic in the document.

The system 200 additionally includes the application component 106, which can be or include an advertisement component 202 that retrieves advertisements to display in a web page based at least in part upon determinations made by the topic model component 104. For instance, the advertisement component 202 may correspond to a program or script included in a web page and/or accessed by the web page.

In an example, the document received by the document receiver component 102 can be a web page, and the topic model component 104 can be trained to analyze the content of the web page and provide an indication of whether one or more particular topics are included in the web page to the advertisement component 202. For instance, the topic model component 104 may determine if a topic pertaining to the sport of baseball is included in the web page. The advertisement component 202 may access a data store 204 that includes a plurality of advertisements and retrieve one or more advertisements to display on the web page, wherein the plurality of advertisements are compatible with the topics that may or may not have been identified in the web page by the topic model component 104.

Topics in web pages that may not be compatible with one or more advertisements may include topics with sensitive content referred to herein as sensitive topics. Sensitive topics correspond to subject matter that is designated by an advertiser as undesirable for display with their advertisements. Such sensitive topics may correspond to subject matter related to violence, sex, pornography, war, or other content that may negatively impact the effectiveness of the particular advertisement. The advertisements stored in the data store 204 may be stored in association with information which specifies one or more sensitive topics capable of being determined by the topic model component 104 for which the respective advertisements are not to be displayed therewith. The advertisement component 202 may then select for displaying with the web page, at least one advertisement from the data store 204, which selected advertisement is not associated in the data store 204 with a topic indentified by the topic model component 104 in the web page as being a sensitive topic for that advertisement.

In another example, the document received by the document receiver component 102 may be a web page that includes reviews of a product. The topic model component 104 may be trained to analyze the product reviews and provide an indication of whether one or more topics are included in the web page. In this example, the topic model component 104 can determine which portions of the web page content (e.g. which reviews) correspond to positive reviews, negative reviews, and/or neutral reviews for the product. The advertisement component 202 may access the data store 204 and select one or more advertisements to display based at least in part upon the determinations of the topic model component 104 (e.g., determination of which portions correspond to positive reviews, which portions correspond to negative reviews, . . . ). Thus, the advertisement component 202 may select advertisements from the data store 204 to display adjacent a review based on whether the review is indicated as positive or negative by the topic model component 104.

For example, if the review criticizes features of the product, the topic model component 104 may identify the review as corresponding to a negative review topic and the advertisement component 202 may select an advertisement for display adjacent the review that is targeted to negative reviews for the particular product (e.g. an advertisement for a competitive product). Also, for negative reviews, the advertisement component 202 may select an advertisement that is targeted to overcoming the negative features included in the portions of the review flagged as negative by the topic model component 104.

In cases where the review positively emphasizes features of the product, the topic model component 104 may identify the review as corresponding to a positive review topic and the advertisement component 202 may select an advertisement for display adjacent the review that is targeted to positive reviews for the particular product (e.g. an advertisement for the product). For positive reviews, the advertisement component 202 may also select an advertisement that is targeted to the positive features included in the portions of the review flagged as positive by the topic model component.

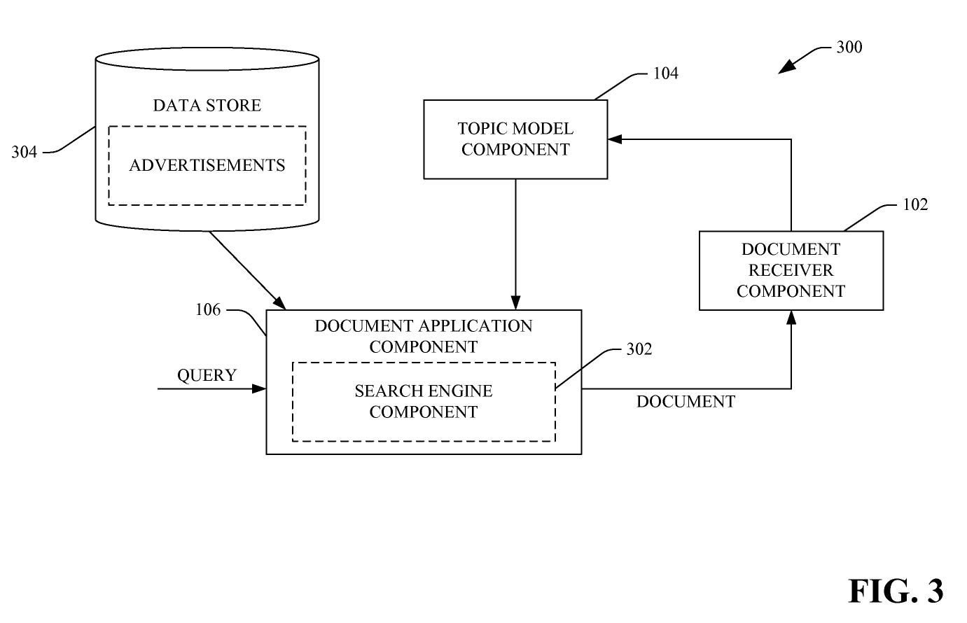

With reference now to FIG. 3, an example system 300 that facilitates selection and/or labeling of an advertisement based at least in part upon whether or not a document includes a particular topic is illustrated. The system 300 includes the document receiver component 102 and the topic model component 104, which act in conjunction as described above. The system 300 additionally includes the document application component 106 that can be or include a search engine component 302.

In an example, the search engine component 302 can generate a web page that displays advertisements adjacent to a listing of web pages and/or images (and in some cases a small portion of the content of the web pages) based at least in part upon a received query. The web page generated by the search engine component 302 may be the document received by the document receiver component 102 and analyzed by the topic model component 104.

Conventionally, search engines (e.g., the search engine component 302) serve advertisements on web page that includes search results listings based at least in part upon a received query and/or information included in the search results listings. Thus, if a user uses a search engine to find a listing of web pages corresponding to a keyword such as “lawnmowers,” the search engine component 302 can display one or more advertisements targeted to lawnmower sales together with search results that are provided in response to the query.

As discussed previously, however, although some content in the search results listing (or the keyword search itself) may identify a lawnmower for which advertisements are available, other content of the search result listing (even if only a very small part of the listing) may be of a nature that makes displaying an advertisement for lawnmower sales undesirable. For example, if the web page also includes a discussion of people suffering from hearing loss using lawnmowers or accidents caused by lawnmowers, an advertiser may find it undesirable to have its advertisement for lawnmowers displayed with such content on the same web page. Discussion of accidents or injuries may correspond to a sensitive topic for lawnmower advertisements.

Accordingly, the topic model component 104 can analyze a web page generated by the search component 302 prior to advertisements being selected for display on the web page. More specifically, the topic model component can be trained to identify whether document content (e.g., web page content) corresponding to a search results listing includes one or more sensitive topics for one or more advertisements stored in a data store 304 (e.g., content regarding accidents or injuries). In this example, the search engine component 302 can provide all or a portion of the content of the search results listing to the document receiver component 102 for use by the topic model component 104 in providing an indication of whether (and where) one or more topics are included in the listing. The search engine component 302 may receive the indication provided by the topic model component 104 and can and retrieve one or more advertisements from the data store 304 that are compatible with the topics that have been identified in the web page by the topic model component 104. Thus, advertisements stored in association with one or more sensitive topics in the data store 304 can be omitted from the list of advertisements displayed in a search results listing identified by the topic model component 104 as including such sensitive topics.

The previously discussed advertisement component 202 and search engine component 302 have been described as components that avoid selection of advertisements which are associated in a data store with sensitive topics identified in a web page or search results listing by the topic model component 104. It is to be understood, however, that in examples of these systems, an advertisement component or search engine component may actively select advertisements from the data store 204, 304 that have been previously associated in the data store with one or more topics considered desirable by an advertiser to display with their advertisement. For example, with respect to the search engine example described previously, when the topic model component 104 indicates that a particular topic (e.g. accident or injury content) is present in the search results listing, the search engine component 302 may select advertisements targeted to such content (e.g. advertisements for medical supplies, first aid kits). In some examples, such advertisements may be selected based on the advertisement being associated in the data store with the identified desirable topic, even when the advertisements are not associated with the keyword(s) used to generate the search results listing.

In further examples, advertisements stored in the data stores 204, 304, may be associated with either one or both of desirable topics and sensitive topics. Also, it is to be understood, that the a topic capable of being identified by the topic model component 104 could be flagged in the data store as sensitive for one advertisement and flagged in the data store as desirable for another advertisement.

In the previous discussion with respect to the example system 300 illustrated in FIG. 3, the topic model component 104 has been described as being used to facilitate selecting appropriate advertisements based on topics identified and/or not identified in the documents and/or search results listings generated by the search engine component 302. However, in alternative examples, the search engine component 302 may (additionally or alternatively) generate a search results listing itself based on the topics identified and/or not identified in a corpus of documents being searched.

For example, the query received by the search engine component 302 may specify a topic (rather than or in addition to one or more keywords) for which the search engine component 302 generates a search results listing that identifies documents that include the topic being queried. To enable a user to provide a topic for a query, the search engine component 302 may be associated with a web page or other interface that provides a user with a plurality of selectable topics to use in a query.

An example of a topic that may be available to be selected may include a topic indicative of medical issues. In response to receiving a query including such a topic, the search engine component 302 may provide a search results listing of documents that have been previously evaluated and tagged in a data store by a topic model component 104 as including content indicative of the topic (e.g. medical issues).

Searching by topic may enable a user to find relevant documents that may not be identifiable by common keywords. For example, in a query for documents describing lawnmower accidents, a keyword search including the words “lawnmower” and “accident” may not locate documents that use alternative language such as “injury”. However, a query that includes a search for the keyword “lawnmower” and the topic “medical issues” may be used by the search engine component 302 to identify documents that include both the keyword “lawnmower” in the same portions of documents that have been identified by a topic model component 104 as including content indicative of medical issues.

In examples, the corpus of documents capable of being searched via topic may be previously evaluated by one or more topic model components 104 with respect to one or more different topics capable of being queried using a search engine component. The indication of the presence or absence of the topics in the documents, and/or the specific location of the portions of the documents that include the topics may be stored and/or indexed in one or more data stores used by the search engine component to generate a search results listing.

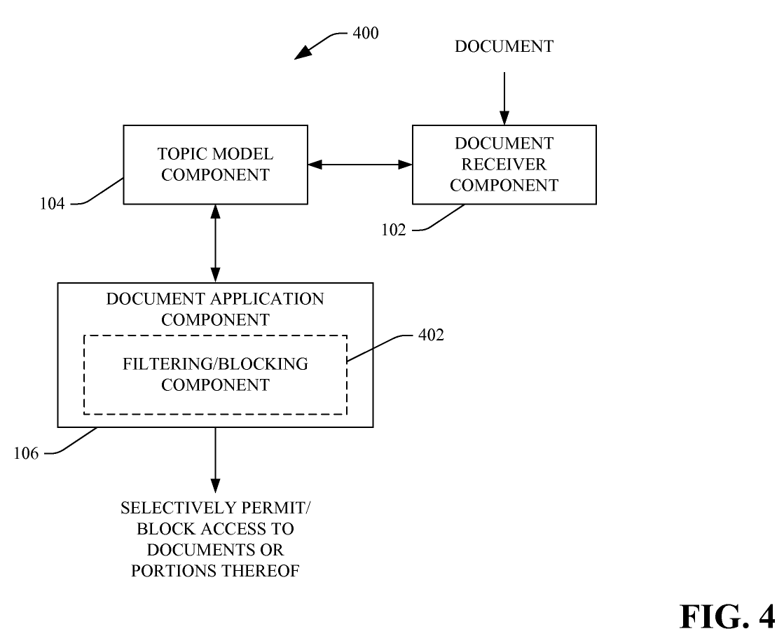

Referring now to FIG. 4, an example system 400 that facilitates filtering/blocking content based at least in part upon a determination of whether a document includes a particular topic is illustrated. The system 400 includes the document receiver component 102 and the topic model component 104, which can act as described above. The system 400 may additionally include the document application component 106 that may be or include a filtering/blocking component 402. Pursuant to an example, the filtering/blocking component 402 may be used by or integrated into a web browser, text messaging application, e-mail application, operating system, or other application on a client, firewall, or server, and can analyze determinations provided by the topic model component 104 prior to allowing certain content in the aforementioned document to be accessed or displayed to a user. For example, the filtering/blocking component 402 on a personal computer (used by a child, for example) may be configured to block all web pages that include one or more sensitive topics (e.g. pornography, violence or other subject matter) or may configured to “black out” particular identified topics in a document.

Pursuant to an example, the document receiver component 102 can receive a web page (or other document) a user wishes to access and can provide all or a portion of the document to the topic model component 104. The topic model component 104 can be trained to analyze the document and provide an indication of whether one or more sensitive topics are included in the document. In an example, if one or more of the sensitive topics are included in the document, the filtering/blocking component 402 can filter such content and prevent documents including such content from being accessed or displayed by the user. In another example, the topic model component 104 can determine that a sensitive topic is included in the document and can further determine a location of the sensitive topic in the document, and can provide such determinations to the filtering/blocking component 402. The filtering/blocking component 402 may modify portions of the document that include the sensitive topic to be undecipherable to a user. If no sensitive topics are detected in the content by the topic model component 104, the filtering/blocking component 402 may permit the document to be accessed by the user and/or communicated to an application attempting to receive and/or display the document.

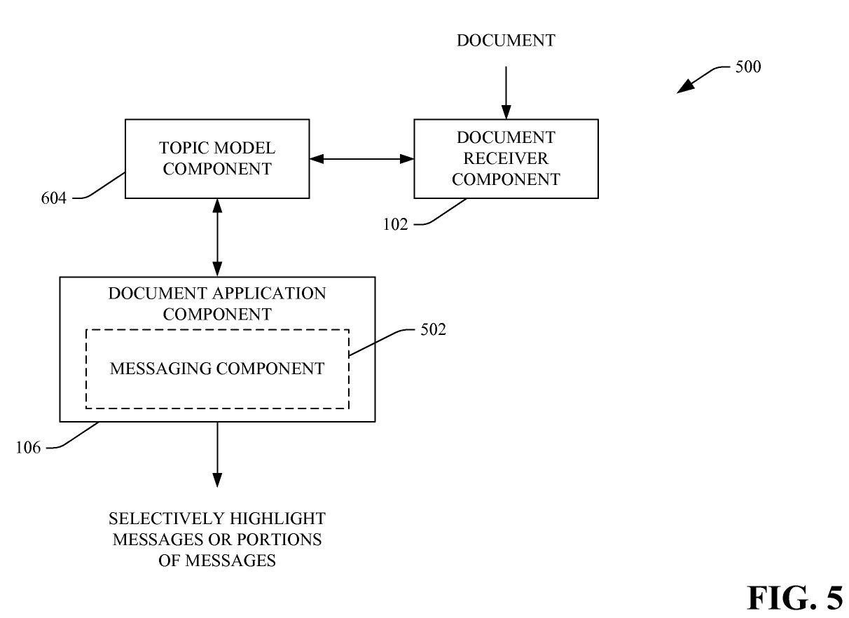

With reference now to FIG. 5, an example system 500 that facilitates selectively highlighting messages or portions thereof is illustrated. The system 500 includes the document receiver component 102 that can receive a document in the form of a message, such as an email message, text message, and/or the like. The topic model component 104 can determine whether the received message includes a particular topic. The system 500 further includes the document application component 106 which can be or include a messaging component 602, such as an e-mail application or text messaging application. As noted above, the topic model component 104 can be trained to identify particular topics in an e-mail, text message, or other message. For example, many e-mails and/or portions of e-mails include content that mainly provides information. However, some e-mails, and/or portions of e-mails include content corresponding to a request for addition information, or may include a request to carry out some action. The topic model component 104 may be trained to identify which portions of an e-mail or other message includes a topic corresponding to information that requests a response or action to be carried out by the receiver of the e-mail.

The messaging component 502 may highlight (e.g., visually emphasize or filter) messages such as e-mails that include content identified by the topic model component 104 as corresponding to a topic representative of a request for information or an action. Also, information provided by the topic model component 104 may be used by the messaging component 502 to highlight portions of e-mails or other messages that likely correspond to a request for information or an action to be carried out.

As can be discerned from the above, the topic model component 104 can analyze textual, audible, and/or visual (e.g., photographic) content in a document for purposes of identifying portions of the document indicative of and not indicative of a topic. In addition, the topic model component 104 can evaluate hidden information such as metadata, formatting characteristics of the document, graphical information, and/or other patterns that can be used to identify portions of a document indicative of and not indicative of a topic in the document. For instance, in the previously discussed e-mail example, the topic model component 104 may evaluate the e-mail header information and/or the location of information in relation to the formatting of the e-mail, to determine if the request for a response or an action is to be carried out by the user of the e-mail application, or by some other recipient of the message. Also, for instance, in the previously discussed product reviews example (e.g., described with respect to FIG. 2), the topic model component 104 may evaluate the HTML tags in the web page to determine the beginning and end of each product review.

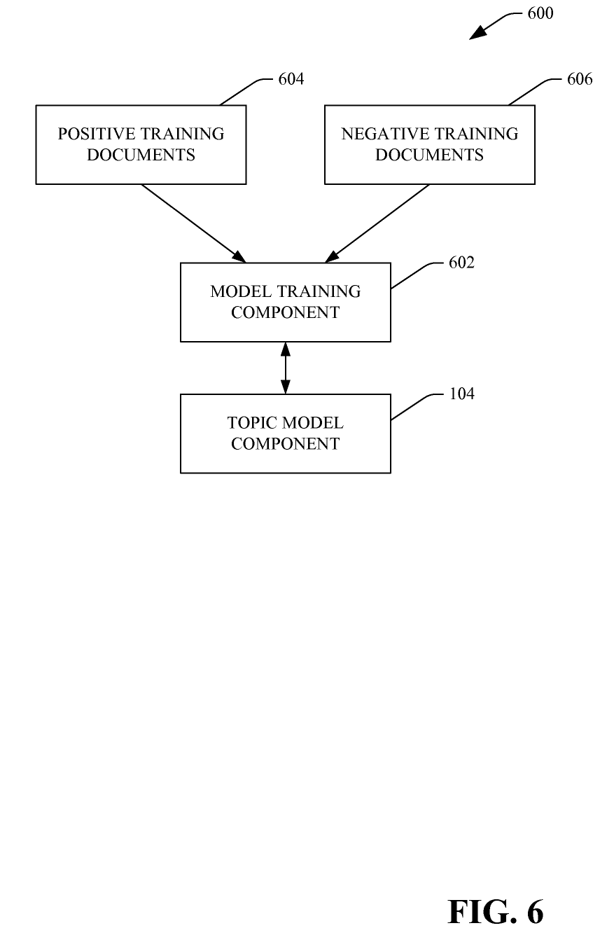

Now turning to FIG. 6, an example system 600 that facilitates training the topic model component 104 to determine whether a document includes a particular topic is illustrated. The system 600 includes a model training component 602 that carries out a learning process such as an MIL process or other machine learning process, wherein the training is used to cause the topic model component 104 to recognize which portions of a document include and which portions do not include information indicative of a topic. The model training component 602 can train the topic model component 104 using at least two sets of training documents: positive training documents 604 and negative training documents 606. The positive training documents 604 include documents in which at least a small portion of the content in each document includes subject matter indicative of the topic that the model training component 602 is being trained to identify in documents. The positive training documents 604 may be tagged as including subject matter indicative of the topic, but a precise location of such subject matter need not be identified. The negative training documents 606 include documents in which no portion of the content in each document includes subject matter indicative of the topic that the model training component is being trained to identify in documents.

In an example, although the negative training documents do not include content indicative of the topic being trained, such negative training documents may include content that generally corresponds to the type of non-relevant content found in the positive documents. For example, if the topic being trained corresponds to a sensitive topic such as violence and many of the non-relevant portions of the positive training documents include news articles, then documents which include news articles may be selected for use as the negative training documents.

To carry out a MIL process, the model training component 602 can analyze the negative set of training documents 604 and attempt to detect or quantify features that are not indicative of the topic. Such features may include words, groups of words, phrases, word groupings, word associations, word placement, content formatting, and/or any other patterns of text or non-text based information. The model training component 602 can compare the identified features from the negative training documents to features in the positive set of training documents to determine a group of features present in the positive set that may correspond to features that are indicative of the topic being trained to detect (e.g., features not indicative of the types of features found in the negative documents). The model training component 602 may further analyze this identified group of potential features indicative of the topic to determine common features across the positive training documents 604. In addition, the model training component 602 may further substantially eliminate, from the group of potential features indicative of the topic, those features which are determined to be substantially unlike other features in the group.

The model training component 602 may then use these identified features with the topic model component 104 to analyze the contents of the positive training documents and/or the negative teaching documents to determine how proficient the topic model component 104 is at identifying content indicative of the topic as being present in the positive training documents 604 and not being present in the negative set of documents 606. In an example, the topic model component 104 may assign a relevancy score to parts of the documents and to the documents as a whole. Based on the results of the scorers for the negative and/or positive sets of training documents, the model training component 602 may adjust the features used to distinguish relevant and non-relevant content in the negative and positive sets of documents, and cycle through these described functions again to produce a new set of scores. The model training component 602 may continue this iterative process to identify a combination of features which generates substantially maximum relevancy scores for the positive training documents 604, and substantially minimum relevancy scores for the negative training documents 606.

In further examples, the model training component 602 may carry out a boosting learning process in combination with MIL to enhance the performance of the learning process. For example, boosting may be implemented to combine multiple learners to create a relatively strong learner.

As is apparent from the preceding discussions, a topic being identified in a portion of a document by the described topic model component 104 corresponds to more than a keyword. Subject matter indicative of a topic includes textual information, textual patterns, formatting patterns, non-textual information patterns, and other features in a document that the topic model component 104 has been trained to recognize in a document which includes text, through a learning process such as a multiple instance learning process that evaluates both negative documents confirmed to not include topic and positive documents in which only a small subset of each positive document includes subject matter confirmed to be indicative of the topic. It is also to be understood that embodiments of the topic model component 104 and model training component 602 may be operative to identify multiple related and/or unrelated topics in combination or as alternatives.

In examples described herein, MIL is used to facilitate a learning process where labels of training data are incomplete. Unlike traditional methods where the label of each individual training instance is known, in MIL the labels are known only for groups of instances (also called “bags”). In the above examples, the described documents (e.g. web pages, emails) may be considered as a “bag” while each block of text may be considered as an instance inside this document/bag. In a single-target (2-class) scenario (when a document is or is not indicative of a topic), a document/bag is labeled positive if at least one instance in that document/bag is positive, and a document/bag is labeled negative if all the instances in it are negative. There are no labels on the individual instances in the training documents/bags. Rather, the example, topic model training component 602 includes a MIL algorithm having a content detector/classifier at the sub-document (block/instance) level.

As discussed previously an example topic model training component 602 may employ a boosting learning processing in combination with MIL such as MILBoost. MILBoost may be used in a single-target (2-class) classifying scenario (e.g. labeling blocks/instances of documents/bags that are positive or negative with respect to a sensitive topic). MILBoost may also be extended for use in a multi-target (multiclass) classifying scenario (e.g. identifying positive, negative, and neutral topic content such as in product reviews).

For example, in the product review example, “positive” and “negative” reviews can be treated as the target classes and the “neutral” review as the null class in an MIL algorithm configuration. In a multi-target scenario, a document/bag is labeled as belonging to class k if it contains at least one instance of class k. As a result, a document/bag can be multi-labeled since it may contain instances from more than two different target classes. For example, in a product review web page, both positive and negative statements may be included on the same page. Thus the entire page may be labeled as having both positive and negative content.

In an example, to handle multi-labels, each training document/bag with multiple labeled content may be duplicated, with each duplicate assigned a different label by the model training component 602. Within each duplicate document/bag, MIL carried out by the model training component 602 will eventually find the blocks/instances that match the label of the document/bag.

When a training process is first begun on a set of training documents, the model training component 602 may be configured to first break the training documents/bags into blocks/instances and to initially guess the block/instance level labels. The block/instance labels may then be combined by the model training component 602 to derive bag/document labels. The model training component 602 may then check if determined bag/document labels are consistent with the predetermined training labels. If not, the model training component 602 can adaptively adjust the probability of membership of the training block/instances until the determined bag/document labels become consistent with the predetermined labels.

With respect to MILBoost, the weight of each block/instance changes in each iteration according to a prediction made by an evolving boosting ensemble carried out by the model training component 602. For instance, initially, all blocks/instances get the same label as the bag/document label for training a first classifier for the topic model component 104. Subsequent classifiers for the topic model component 104 may be trained by reweighted blocks/instances based on the output of the existing weak classifiers. Examples of base classifiers that may be used by the topic model component 104 and trained by the model training component 602 using MILBoost include Naive Bayes, decision trees, or other classifier model.

With respect to multi-class MILBoost, there may be 1 to K target classes and class 0 may be the null class. For each block/instance xᵢⱼ of document/bag [symbol] the probability that xᵢⱼ belongs to class k (k ε{1, 2, . . . ,K}) is given by a softMax function:

$${P}_{ijk} = \frac{{e}^{Yijk}}{{\sum }_{c = 0}^{K} {e}^{Yijc}} \\ where \text{:} \\ {Y}_{ijk} = {\sum }_{t} {λ}_{{ty}_{ijk}^{t}} \qquad ( 1 )$$

is the weighted sum of the output of each classifier in the ensemble with t steps. Here {Yᵢⱼₖ^{t}} is the output score for class k from block/instance xᵢⱼ generated by the t^{th} classifier of the ensemble.

In this example, a document/bag may be labeled as belonging to class k if it contains at least one instance of class k. If it contains no blocks/instances with labels 1 to K, then it is labeled as neutral or the null class. Under this definition, the probability that a document/bag has label k is the probability that at least one of its blocks/instances has label k. Given the probability of each instance belonging to target class k, and assuming that the blocks/instances are independent of each other, the probability that a document/bag belongs to any target class k (k>0) is

$${P}_{ik} = 1 - {\prod }_{j ∈ i} ( 1 - {P}_{ijk} ) . \qquad ( 2 )$$

This example may correspond to “noisy OR” model.

The probability that a document/bag is neutral (or belongs to the null class 0) can be substantially similar to the probability that all the blocks/instances in the document/bag are neutral: Pᵢ₀=1−Π_{jεi}Pᵢⱼₖ.

The log likelihood of all the training documents, can be given as

$$log LH = {\sum }_{k = 1}^{K} {\sum }_{\{ i \vert {l}_{i} = k \}} log {P}_{ik} + {\sum }_{i \vert {l}_{i} = k} log {P}_{i 0} \qquad ( 3 )$$

where lᵢ is the label of document/bag Bᵢ.

An example of the model training component may use an AnyBoost framework. With AnyBoost, the weight on each block/instance for the next round of training is given as the derivative of the log likelihood function with respect to a change in the score of the block/instance. Thus with AnyBoost the target classes are:

$${w}_{ij} = \frac{\partial log LH}{\partial {Y}_{ijk}^{{l}_{i = k}}} = \frac{1 - {P}_{ik}^{{l}_{i} = k}}{{P}_{ik}^{{l}_{i} = k}} {P}_{ijk}^{{l}_{i} = k} , ∀ i ∈ \{ i \vert {l}_{i} > 0 \} \qquad ( 4 )$$

and the null class is:

$${w}_{ij} = \frac{\partial log LH}{\partial {Y}_{ij 0}} = 1 - {P}_{ij 0} ∀ i ∈ \{ i \vert {l}_{i} > 0 \} \qquad ( 5 )$$

In a single target (2-class) MultiBoost case, the weight may correspond to:

$${w}_{ij} = \frac{\partial log LH}{\partial {y}_{ij}} = \frac{{l}_{i} - {p}_{i}}{{p}_{i}} {p}_{ij} \qquad ( 6 )$$

Here the weight on each instance can evolve to keep the learner focusing on the concepts that are not absorbed so far by the ensemble. The overall weight may be composed of two parts: document/bag weight

$$\frac{{l}_{i} - {p}_{i}}{{p}_{i}}$$

and block/instance weight pᵢⱼ.

For a block/instance in a negative document/bag, the document/bag weight is −1, while the block/instance weight determines the magnitude of the weight. Generally, negative blocks/instances with a high pᵢⱼ can get a high weight (in magnitude) for a next round of training, since they are more likely to cause misclassification at the document/bag level. For a positive document/bag, if it is correctly classified (pᵢ is high), the weight of all the blocks/instances in the document/bag can be reduced. Otherwise, blocks/instances with higher pᵢⱼ within the document/bag, which are potentially good candidates for “real positive” blocks/instances, may stand out and receive more attention in the next round of training.

The following pseudo-code is an example of a single target (2-class) MILBoost algorithm that the model training component 602 may carry out to train the example model topic component 104:

Input: Training set T of N bags, each bag Bᵢ with nᵢ instances xᵢⱼ, bag label
lᵢ ∈ {0, 1}, base learner l, integer M (number of training rounds)
#Initialize weights
for i = 1: N

for j = 1: nᵢ

let wᵢⱼ⁰ = 2 * (lᵢ − 0.5);
endfor

endfor
for t = 1: M

#Train base (weak) classifier with weighted instances
C^{t} = l(T, W^{t-1});
#Combining weak classifiers − Line search for [symbol] ₜ [symbol]
ₜ = argmax [symbol] logLH; #refer to (1)
#Update instance weights using Anyboost
for i = 1: N

for j = 1: nᵢ

#Compute instance probability
let yᵢⱼ = Σₖ₌₁_{₁}^{t} [symbol] ₖ C_{K}(xᵢⱼ);
$let {P}_{ij} = \frac{1}{1 + exp ( - {y}_{ij} ) ;}$

endfor
#Compute bag probability
let pᵢ = 1 − Π_{j∈B}_{ᵢ}(1 − pᵢⱼ);
#Update instance weights
for j = 1 : n₁
$let {w}_{ij}^{t} = \frac{{l}_{i} - {p}_{i}}{{p}_{i}} {p}_{ij} ;$
endfor

endfor

endfor
Output: ensemble classifier {C₁, C₂, . . . , C_{M}},
classifier weights: { [symbol] ₁, [symbol] ₂, . . . , [symbol] _{M}}

In multi-target MILBoost, the weight of each block/instance may be positive unlike the single-target (2-class) MultiBoost case. Thus, the class information may no longer be carried by the sign of the weight, as in the single-target (2-class) MultiBoost case. However, similar to the single-target (2-class) MILBoost, the weights on blocks/instances of a target class document/bag may reduce as the ensemble prediction of the document/bag approaches the document/bag label. Otherwise, blocks/instances with high probability of being the target class can be singled out for next round of training. Once the (t+1)th classifier is trained, the weight on the classifier [symbol] ₜ₊₁ can be obtained by a line search to maximize the log likelihood function.

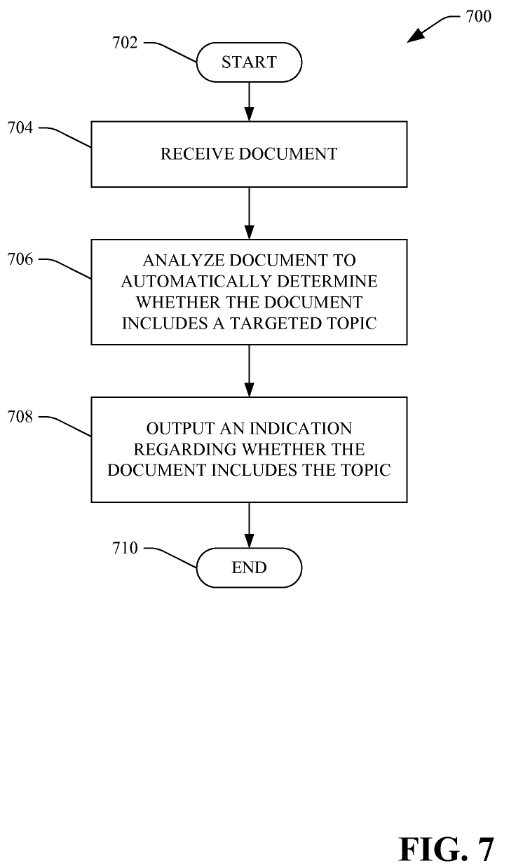

With reference collectively to FIGS. 7-11, various example methodologies are illustrated. While these methodologies are described as being a series of acts that are performed in a sequence, it is to be understood that the methodologies are not limited by the order of the sequence. For instance, some acts may occur in a different order than what is described herein. In addition, an act may occur concurrently with another act. Also, an act can correspond to inaction such as a time delay. Furthermore, in some instances, not all acts may be required to implement a methodology described herein.

Moreover, the acts described herein may be computer-executable instructions that can be implemented by one or more processors and/or stored on a computer-readable medium, media, or articles. The computer-executable instructions may include a routine, a sub-routine, programs, a thread of execution, and/or the like. Still further, results of acts of the methodologies may be stored in a computer-readable medium, displayed on a display device, and/or the like.

Now referring to FIG. 7, an example methodology 700 for determining/locating information in a document that is indicative of a topic is illustrated. The methodology starts at 702, and at 704 a document is received. At 706, the received document is analyzed to determine whether or not information indicative of a targeted topic is included in the received document. For instance, documents often include multiple topics. At 708, information is output that indicates whether or not information indicative of the topic is included in the document. The output information may also identify which portions of the document are and are not indicative of the topic. The methodology 700 completes at 710.

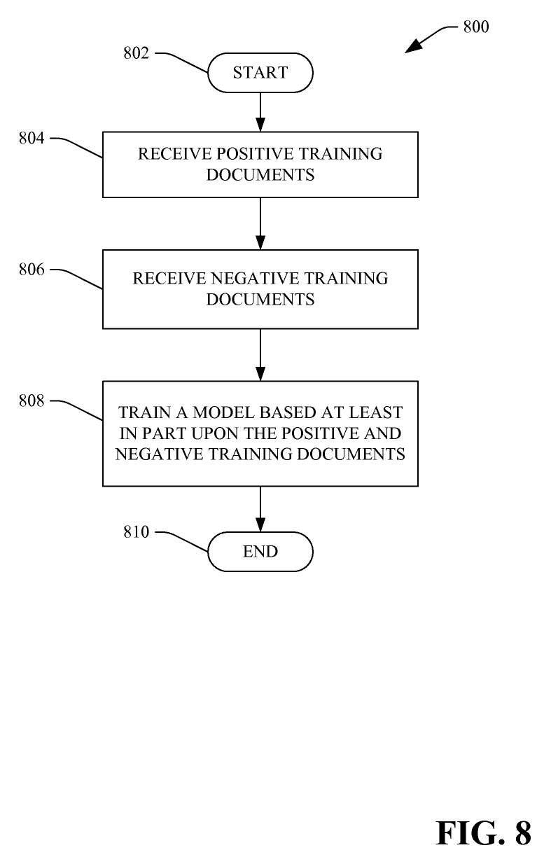

With reference now to FIG. 8, an example methodology 800 for training a component that can be used to identify information indicative of a topic in a document that includes multiple topics is illustrated. The methodology 800 starts at 802, and at 804 positive training documents are received. As noted above, positive training documents include documents that include subject matter indicative of a topic that is desirably automatically located. At 806, negative training documents are received (e.g., documents that do not include subject matter indicative of a topic). At 808, a model is trained using any suitable learning process, such as multiple instance learning, based at least in part upon the documents received at 804 and 806. The methodology 800 completes at 810.

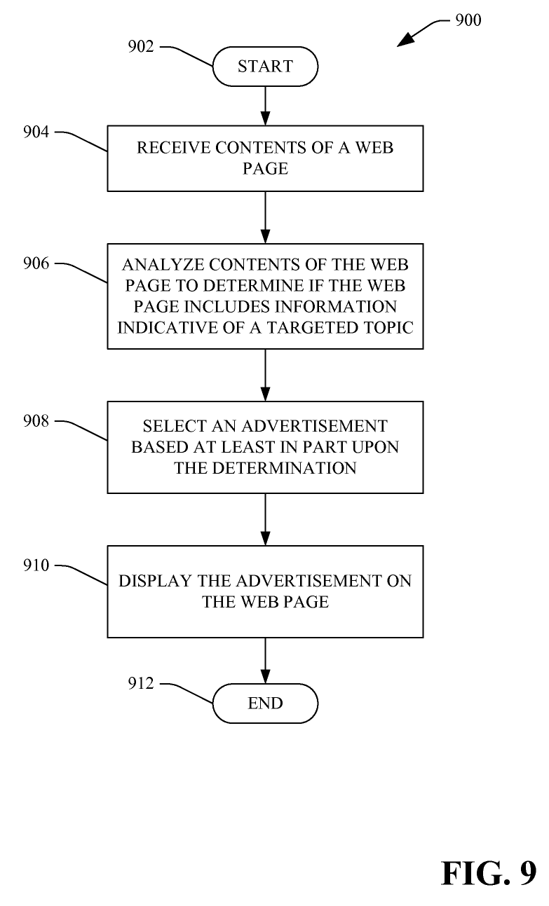

With reference to FIG. 9, an example methodology 900 for displaying advertisements is illustrated. The methodology 900 starts at 902, and at 904 contents of a web page are received. At 906, contents of the received web page are analyzed to determine if the web page includes information indicative of a targeted topic. If it is determined that the web page includes information indicative of the targeted topic, then at 908 an advertisement can be selected based at least in part upon the determination that the web page includes the information indicative of the targeted topic. At 910, the chosen advertisement may be displayed on the web page. The methodology 900 completes at 912.

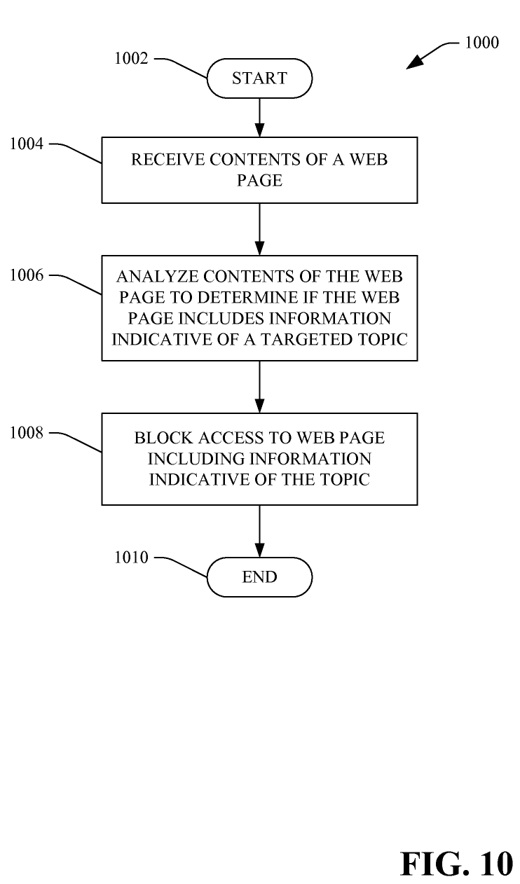

Referring now to FIG. 10, an example methodology 1000 for filtering/blocking web pages is illustrated. The methodology 1000 starts at 1002, and at 1004 contents of a web page are received. At 1006, contents of the received web page are analyzed to determine if the web page includes information indicative of a targeted topic. If it is determined that the web page includes information indicative of the targeted topic, then at 1008, access to the web page is prevented. For instance, the targeted topic may be a sensitive topic. In another example, a portion of the web page that includes the targeted topic may be modified to effectively block subject matter pertaining to the targeted topic. The methodology 1000 completes at 1010.

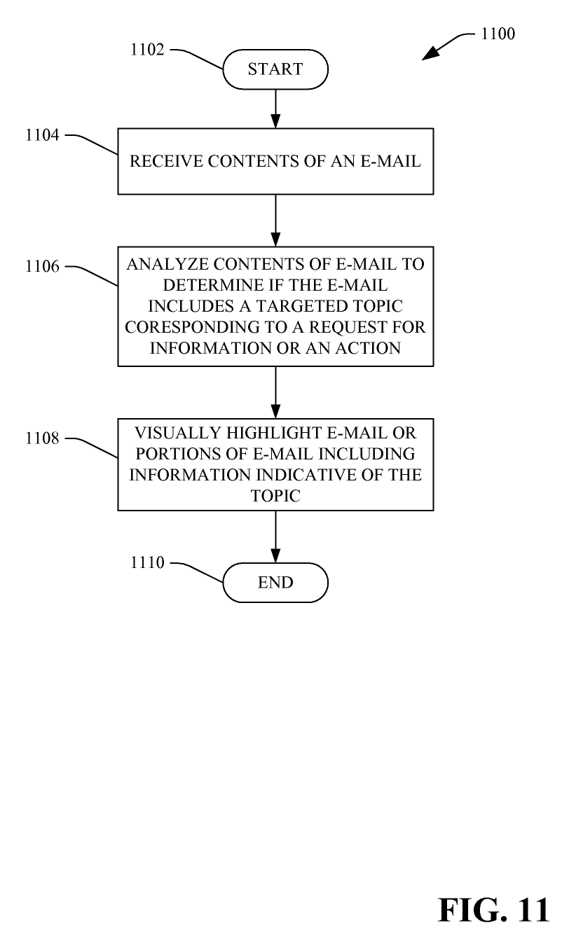

Turning now to FIG. 11, an example methodology 1100 for highlighting messages such as e-mails that include requests for information or an action is illustrated. The methodology 1100 starts at 1102, and at 1104, contents of an e-mail are received. At 1106, contents of the received e-mail are analyzed to determine if the e-mail includes a targeted topic corresponding to a request for information or an action to be taken. If it is determined that the e-mail includes information indicative of the targeted topic, then at 1108, the e-mail is visually highlighted or marked. The methodology 1100 then completes at 1110.

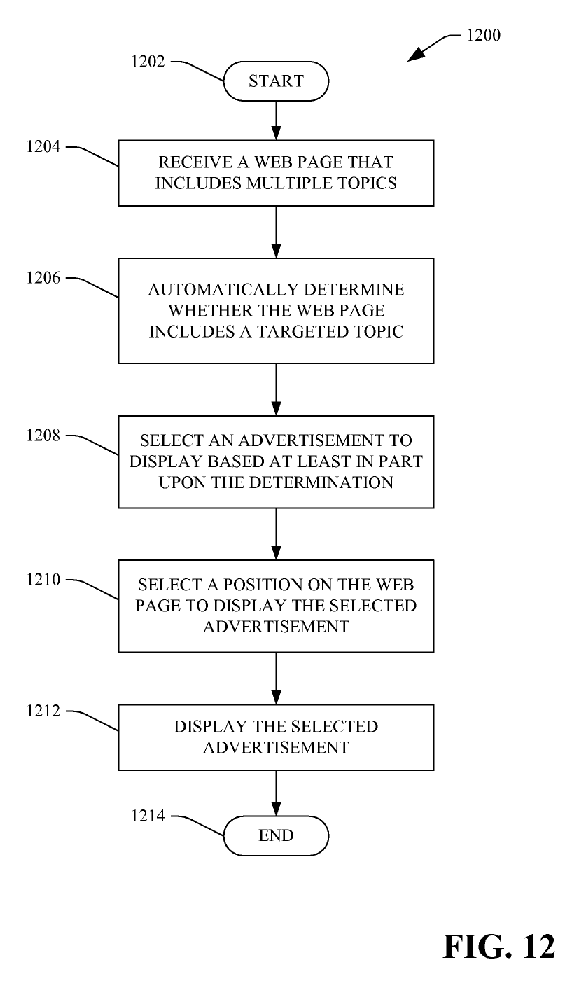

Now referring to FIG. 12, an example methodology 1200 for selectively displaying an advertisement on a web page is illustrated. The methodology 1200 start at 1202, and at 1204 a web page that includes multiple topics is received. At 1206, an automatic determination is made regarding whether the web page includes a targeted topic. Further, if the web page includes the targeted topic, a determination can be made regarding a location on the web page of the targeted topic. The determination of whether the web page includes the targeted topic can be output by a machine-learned model that may be trained by way of multiple instance learning.

At 1208, an advertisement to display on the web page can be selected based at least in part upon the determination of whether the web page includes the targeted topic. At 1210, if the web page includes the targeted topic, a position on the web page to display the selected advertisement can be determined based at least in part upon the determination of the location on the web page of the targeted topic. At 1212, the advertisement may be displayed at the selected position on the web page. The methodology 1200 completes at 1214.

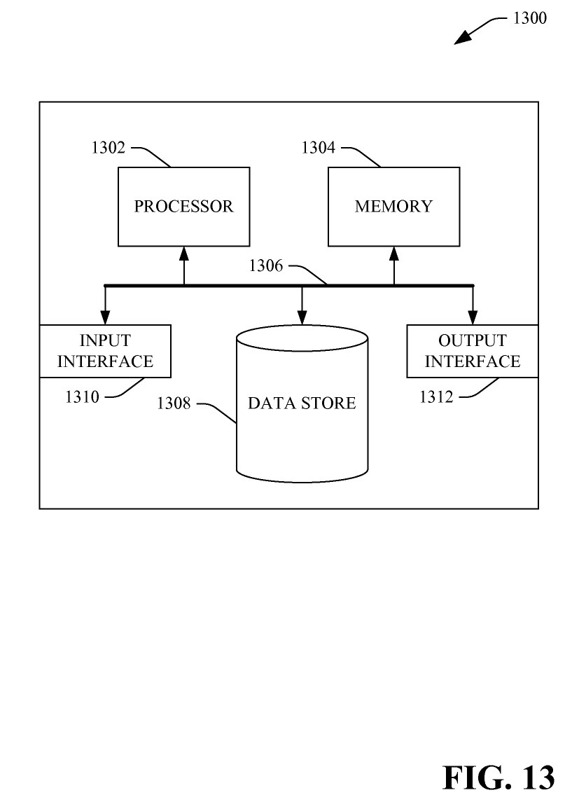

Now referring to FIG. 13, a high-level illustration of an example computing device 1300 that can be used in accordance with the systems and methodologies described herein is depicted. For instance, the computing device 1300 may be used in a system that can be used in connection with automatically determining whether a document includes a particular topic. In addition, the computing device 1300 may be employed in connection with training an algorithm/model to determine whether subject matter indicative of a particular topic is included in a document. The computing device 1300 includes at least one processor 1302 that executes instructions that are stored in a memory 1304. The instructions may be, for instance, instructions for implementing functionality described as being carried out by one or more components discussed above or instructions for implementing one or more of the methods described above. The processor 1302 may access the memory by way of a system bus 1306. In addition to storing executable instructions, the memory 1304 may also store documents, advertisements, etc.

The computing device 1300 additionally includes a data store 1308 that is accessible by the processor 1302 by way of the system bus 1306. The data store 1308 may include executable instructions, advertisements, data models, documents, etc. The computing device 1300 also includes an input interface 1310 that allows external devices to communicate with the computing device 1300. For instance, the input interface 1310 may be used to receive instructions from an external computer device, receive web pages from a web server, receive a request for a web page, etc. The computing device 1300 also includes an output interface 1312 that interfaces the computing device 1300 with one or more external devices. For example, the computing device 1300 may transmit data to a personal computer by way of the output interface 1312.

Additionally, while illustrated as a single system, it is to be understood that the computing device 1300 may be a distributed system. Thus, for instance, several devices may be in communication by way of a network connection and may collectively perform tasks described as being performed by the computing device 1300.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A system that facilitates detecting a targeted topic in a document that includes multiple topics, comprising:
a receiver component that receives a document; and
a topic model component trained using a plurality of training documents including the topic and a plurality of training documents that do not include the topic, wherein the topic model component analyzes the document and automatically determines which portions of the document include the topic and which portions of the document do not include the topic.

2. The system according to claim 1, further comprising a document application component that outputs information based at least in part upon at least one of the determined portions of the document that include the topic and the determined portions of the document that do not include the topic.

3. The system according to claim 2, wherein the document application component outputs at least one advertisement based at least in part upon at least one of the determined portions of the document that include the topic and the determined portions of the document that do not include the topic.

4. The system according to claim 2, further comprising a data store including a plurality of advertisements, wherein at least one first advertisement specifies the topic as corresponding to a sensitive topic, wherein at least one second advertisement does not specify the topic as corresponding to a sensitive topic, wherein the document application component is responsive to the at least one first advertisement specifying the topic as corresponding to a sensitive topic to not select the at least one first advertisement for displaying with the document determined to have portions that include the topic, wherein the document application component is responsive to the at least one second advertisement not specifying the topic as corresponding to a sensitive topic to select the at least one second advertisement for displaying with the document determined to have portions that include the topic.

5. The system according to claim 2, wherein the document application component includes a search engine component that outputs a listing of documents with content indicative of a topic specified in a search query.

6. The system according to claim 2, wherein the document application component includes a messaging component that selectively highlights a portion of an e-mail message based at least in part upon determinations output by the topic model component.

7. The system according to claim 1, further comprising a document application component that blocks access to the document if the document includes the topic.

8. The system of claim 1, wherein the topic model component is trained using multiple instance learning.

9. A method, comprising:
receiving a document;
analyzing the document to automatically determine whether the document includes a targeted topic using a topic model component trained using a plurality of training documents including the topic and a plurality of training documents that do not include the topic; and
outputting an indication regarding whether the document includes the topic.

10. The method of claim 9, further comprising selecting an advertisement based at least in part upon the output indication.

11. The method of claim 10, further comprising selecting an advertisement based at least in part upon the output indicating that the document does not include the topic.

12. The method of claim 9, wherein the document is an e-mail document, and further comprising outputting an indication that the e-mail document includes the topic.

13. The method of claim 12, further comprising:
identifying a portion of the document that includes the topic; and
outputting an indication that the identified portion of the e-mail includes the topic.

14. The method of claim 13, further comprising highlighting the portion of the document that includes the topic.

15. The method according to claim 9, wherein the document is a web page, and further comprising blocking the web page from being accessed based at least in part upon an indication that the document includes the topic.

16. The method of claim 9, wherein multiple instance learning is employed in connection with training the topic model component.

17. The method of claim 9, further comprising:
determining that the document includes the topic;
determining at least one location of the topic in the document; and
visually altering the at least one location in the document to render information in the at least one location undecipherable based at least in part upon the determination that the document includes the topic and the determined location of the topic in the document.

18. The method of claim 9, further comprising:
receiving a search query that specifies the topic; and
outputting a listing of documents that have been identified by the topic model component as including content indicative of the topic.

19. The method of claim 9, wherein the received document includes multiple topics.

20. A computer-readable medium comprising instructions that, when executed by a processor, perform the following acts:
receiving a web page that includes multiple topics;
automatically determining whether the web page includes a targeted topic and, if the web page includes the targeted topic, determining a location on the web page of the targeted topic, wherein the determination of whether the web page includes the targeted topic is output by a machine-learned model that is trained by way of multiple instance learning;
selecting an advertisement to display on the web page based at least in part upon the determination of whether the web page includes the targeted topic;
if the web page includes the targeted topic, selecting a position on the web page to display the selected advertisement based at least in part upon the determination of the location on the web page of the targeted topic; and
displaying the advertisement at the selected position on the web page.
